(19) United States
(12) Patent Application Publication
(10) Pub. No.: US 2024/0429497 A1
(43) Pub. Date: Dec. 26, 2024

(54) ALL-SOLID-STATE BATTERY

(71) Applicant: SAMSUNG ELECTRO-MECHANICS CO., LTD., Suwon-si, Gyeonggi-do (KR)

(72) Inventor: Kyunglock Kim, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/280,812

(22) PCT Filed: Apr. 24, 2023
(86) PCT No.: PCT/KR2023/005567

§ 371 Date: Sep. 7, 2023

(30) Foreign Application Priority Data
Jan. 6, 2023 (KR) 10-2023-0002066

(51) Int. Cl. H01M 50/117; C03C 3/064; C03C 4/14; C03C 8/06; C03C 10/16; H01M 10/0562; H01M 50/124

(52) U.S. Cl. CPC H01M 50/117; C03C 3/064; C03C 4/14; C03C 8/06; C03C 10/16; H01M 10/0562; H01M 50/124; C03C 2204/00; C03C 2205/00; H01M 2300/0071; H01M 2300/0094

(57) ABSTRACT

An all-solid-state battery includes a cell stack including a solid electrolyte layer, and a positive electrode layer and a negative electrode layer disposed with the solid electrolyte layer interposed therebetween, and a cover layer on an outer surface of the cell stack. The cover layer includes glass including lithium fluoride (LiF) or glass ceramic including lithium fluoride (LiF).

### TECHNICAL FIELD

The present disclosure relates to an all-solid-state battery.

### BACKGROUND ART

Recently, as portable electronic devices are required to be down-sized and used for a long term, high-capacity batteries are required, and safety of the batteries is also required due to the spread of wearable electronic devices. Accordingly, development of an all-solid-state battery using a solid electrolyte instead of a liquid electrolyte is actively progressing.

Since the all-solid-state battery does not use a flammable organic solvent, additional circuitry for safety may be simplified. Therefore, the all-solid-state battery is expected as a technology capable of manufacturing a safe battery with high capacity per unit volume.

In addition, an oxide all-solid-state battery using an oxide electrolyte with lower ion conductivity (10⁻⁴ S/cm to 10⁻⁶ S/cm) than a sulfide electrolyte (10⁻² S/cm) requires a high-temperature sintering process but exhibits excellent stability, compared with a sulfide all-solid-state battery using the sulfide electrolyte which reacts with oxygen and moisture in the air.

A stacked oxide all-solid-state battery is a micro-sized battery and thus may be mounted on a substrate like a passive device, and in addition, is stable even though exposed at a high temperature in a reflow process for this.

Research is being conducted to apply the stacked oxide all-solid-state battery to various fields, and in particular, demands for an all-solid-state battery with excellent insulating properties and moisture-proof functions are increasing.

### DISCLOSURE OF INVENTION

### Technical Problem

One aspect of the embodiment provides an all-solid-state battery with improved reliability by effectively preventing the penetration of external moisture and having excellent moisture-proof functions and excellent insulation properties to prevent battery failure due to the deposition of lithium (Li) ion precipitates on the negative electrode during battery operation.

However, example embodiments of the present invention are not limited thereto but may be applied in various ways within the scope of the technical idea included therein.

### Solution to Problem

An all-solid-state battery according to an embodiment includes a cell stack including a solid electrolyte layer, a positive electrode layer and a negative electrode layer disposed with the solid electrolyte layer interposed therebetween, and a cover layer on an outer surface of the cell stack. The cover layer includes glass including lithium fluoride (LiF) or glass ceramic including lithium fluoride (LiF).

The glass or glass ceramic may include lithium fluoride (LiF) and lithium (Li) oxide.

The glass or glass ceramic may include lithium fluoride (LiF) and lithium (Li) oxide, silicon (Si) oxide, boron (B) oxide, phosphorus (P) oxide, germanium (Ge) oxide, or combinations thereof.

The glass or glass ceramic includes 5 mol % to 15 mol % of lithium fluoride (LiF), 20 mol % to 75 mol % of lithium (Li) oxide, 0 mol % to 70 mol % of silicon (Si) oxide, 0 mol % to 60 mol % of boron (B) oxide, 0 mol % to 50 mol % of phosphorus (P) oxide, and 0 mol % to 80 mol % of germanium (Ge) oxide, based on a total amount of the glass or glass ceramic.

The solid electrolyte layer may include glass including lithium (Li) oxide and lithium chloride (LiCl) or glass ceramic including lithium (Li) oxide and lithium chloride (LiCl).

The glass or glass ceramic included in the solid electrolyte layer may further include silicon (Si) oxide, boron (B) oxide, phosphorus (P) oxide, germanium (Ge) oxide, or a combination thereof.

The glass or glass ceramic included in the solid electrolyte layer may include 3 mol % to 22 mol % of lithium chloride (LiCl), 20 mol % to 75 mol % of lithium (Li) oxide, 0 mol % to 70 mol % of silicon (Si) oxide, 0 mol % to 60 mol % of boron (B) oxide, 0 mol % to 50 mol % of phosphorus (P) oxide, and 0 mol % to 80 mol % of germanium (Ge) oxide, based on a total amount of the glass or glass ceramic included in the solid electrolyte layer.

The cover layer may be disposed on an outer surface of the positive electrode layer or the negative electrode layer at the outermost side in the stacking direction of the cell stack.

A solid electrolyte layer may be disposed between the cover layer and the positive electrode layer or the negative electrode layer adjacent thereto.

The cell stack may further include a margin layer disposed laterally adjacent to edges of the positive electrode layer and the negative electrode layer.

The margin layer may include glass including lithium fluoride (LiF) or glass ceramic including lithium fluoride (LiF).

An all-solid-state battery according to another embodiment includes a cell stack including a solid electrolyte layer, a positive electrode layer and a negative electrode layer disposed with the solid electrolyte layer interposed therebetween, and a margin layer disposed laterally adjacent to edges of the positive electrode layer and the negative electrode layer. The margin layer may include glass including lithium fluoride (LiF) or glass ceramic including lithium fluoride (LiF).

The glass or glass ceramic may include 5 mol % to 15 mol % of lithium fluoride (LiF), 20 mol % to 75 mol % of lithium (Li) oxide, 0 mol % to 70 mol % of silicon (Si) oxide, 0 mol % to 60 mol % of boron (B) oxide, 0 mol % to 50 mol % of phosphorus (P) oxide, and 0 mol % to 80 mol % of germanium (Ge) oxide, based on a total amount of the glass or glass ceramic.

The solid electrolyte layer may include glass or glass ceramic including 3 mol % to 22 mol % of lithium chloride (LiCl), 20 mol % to 75 mol % of lithium (Li) oxide, 0 mol % to 70 mol % of silicon (Si) oxide, 0 mol % to 60 mol % of boron (B) oxide, 0 mol % to 50 mol % of phosphorus (P) oxide, and 0 mol % to 80 mol % of germanium (Ge) oxide.

The margin layer may extend along an edge of an electrode active material layer of the positive electrode layer or the negative electrode layer.

The margin layer may be stacked on the solid electrolyte layer.

The all-solid-state battery may further include a cover layer on an outer surface of the cell stack, and the cover layer may include glass or glass ceramic including lithium fluoride (LiF).

The all-solid-state battery may include a first external electrode disposed adjacent to one side of the cell stack and the cover layer and connected to the positive electrode layer, and a second external electrode disposed adjacent to the other side of the cell stack and the cover layer and connected to the negative electrode layer.

The positive electrode layer may include a positive electrode current collector and a positive electrode active material layer coated on at least one surface of the positive electrode current collector.

The negative electrode layer may include a negative electrode current collector and a negative electrode active material layer coated on at least one surface of the negative electrode current collector.

The positive electrode current collector may extend toward the one side of the cell stack and be connected to the first external electrode.

The negative electrode current collector may extend toward the other side of the cell stack and be connected to the second external electrode.

An all-solid-state battery according to another embodiment includes a cell stack including a plurality of solid electrolyte layers, a plurality of positive electrode layers and negative electrode layers alternately disposed with the plurality of solid electrolyte layers interposed therebetween, a plurality of margin layers disposed laterally adjacent to edges of the plurality of positive electrode layers and the plurality of negative electrode layers, cover layers on outer surfaces of the cell stack in a stacking direction of the plurality of positive electrode layers and negative electrode layers, and first and second external electrodes disposed laterally adjacent to the cell stack and the cover layers and connected to the plurality of positive electrode layers and the plurality of negative electrode layers, respectively, wherein the plurality of margin layers, the cover layers, or both of the plurality of margin layers and the cover layers include glass including lithium fluoride (LiF) or glass ceramic including lithium fluoride (LiF).

An all-solid-state battery according to another embodiment includes a cell stack including: a positive electrode layer and a negative electrode layer, a solid electrolyte layers disposed between the positive electrode layer and the negative electrode layer, a first margin layer disposed on an end of the positive electrode layer, and a second margin layer disposed on an end of the negative electrode layer; a cover layer disposed on an outer surface of the cell stack in a stacking direction of the positive electrode layer and the negative electrode layer; and first and second external electrodes connected to the positive electrode layer and the negative electrode layer, respectively. One or more of the first margin layer, the second margin layer, and the cover layer include fluoride (F).

Fluoride (F) in the one or more of the first margin layer, the second margin layer, and the cover layer may have a content greater than that of chloride (Cl) in the one or more of the first margin layer, the second margin layer, and the cover layer.

The one or more of the first margin layer, the second margin layer, and the cover layer may further include lithium, and one or more of silicon (Si) oxide, boron (B) oxide, phosphorus (P) oxide, germanium (Ge) oxide, and a combination thereof.

The solid electrolyte layer may include chloride (Cl).

The solid electrolyte layer may further include lithium, and one or more of silicon (Si) oxide, boron (B) oxide, phosphorus (P) oxide, germanium (Ge) oxide, and a combination thereof.

Chloride (Cl) in the solid electrolyte layer may have a content greater than that of fluoride (F) in the solid electrolyte layer.

### Advantageous Effects of Invention

According to the all-solid-state battery according to the embodiment, the cover layer or margin layer includes a material having low ionic conductivity, high impedance resistance, and low electronic conductivity, and thus an all-solid-state battery with improved reliability by effectively preventing the penetration of external moisture, and having excellent moisture-proof functions and excellent insulation properties to prevent battery failure due to the deposition of lithium (Li) ion precipitates on the negative electrode during battery operation.

### BRIEF DESCRIPTION OF DRAWINGS

FIG. 1 is a perspective view schematically illustrating an all-solid-state battery according to an embodiment.

FIG. 2 is a cross-sectional view of the all-solid-state battery taken along the line I-I′ of FIG. 1.

FIG. 3 is an exploded perspective view schematically illustrating a unit cell stack structure of an all-solid-state battery according to the embodiment shown in FIG. 1.

### BEST MODE FOR CARRYING OUT THE INVENTION

Hereinafter, various embodiments of the present invention will be described in detail with reference to the accompanying drawings so that those skilled in the art may easily carry out the present invention. The drawings and description are to be regarded as illustrative in nature and not restrictive. Like reference numerals designate like elements throughout the specification. Further, the accompanying drawings are provided only in order to allow embodiments disclosed in the present specification to be easily understood, and are not to be interpreted as limiting the spirit disclosed in the present specification, and it is to be understood that the present invention includes all modifications, equivalents, and substitutions without departing from the scope and spirit of the present invention. In addition, some constituent elements in the accompanying drawings are exaggerated, omitted, or schematically illustrated, and the size of each constituent element does not entirely reflect the actual size.

In addition, unless explicitly described to the contrary, the word “comprise,” and variations such as “comprises” or “comprising,” will be understood to imply the inclusion of stated elements but not the exclusion of any other elements.

Through the specification, the “stacking direction” refers to a direction in which constituent elements are sequentially stacked or the “thickness direction” perpendicular to the large surface (main surface) of the sheet-shaped constituent elements, which corresponds to a T-axis direction in the drawing. In addition, the “side direction” refers to a direction extending parallel to the large surface (main surface) from the edge of the sheet-shaped constituent elements or a “planar direction.” which corresponds to an L-axis direction in the drawing.

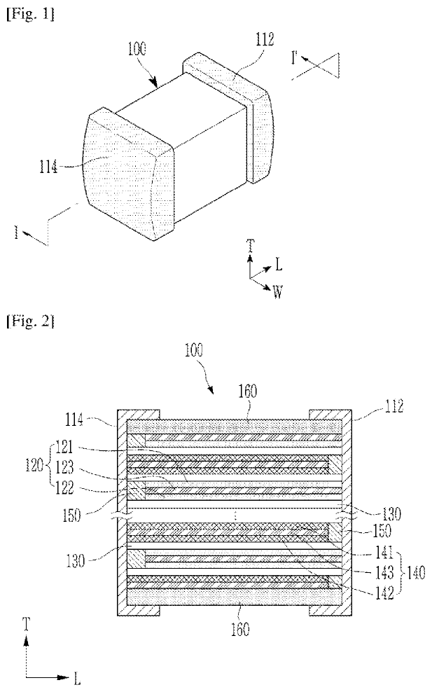

FIG. 1 is a perspective view schematically illustrating an all-solid-state battery according to an embodiment, and FIG. 2 is a cross-sectional view of the all-solid-state battery taken along the line I-I′ of FIG. 1. Hereinafter, an all-solid-state battery will be described in detail with reference to FIGS. 1 and 2.

The all-solid-state battery 100 may have, for example, an approximate hexahedral shape.

In the present example embodiment, for convenience of description, in the all-solid-state battery 100, both surfaces facing each other in a thickness direction (T-axis direction) are defined as first and second surfaces, and both surfaces connected to the first and second surfaces and facing each other in a length direction (L-axis direction) are defined as third and fourth surfaces. For example, the first and second side surfaces of the all-solid-state battery 100 may be the third and fourth surfaces.

The all-solid-state battery 100 according to the present embodiment includes electrode layers 120 and 140 and a solid electrolyte layer 130 adjacent to the electrode layers 120 and 140 in a stacking direction. The electrode layers 120 and 140 may include a positive electrode layer 120 and a negative electrode layer 140, and may basically include the current collectors 123 and 143 and the active material layers 121, 122, 141, and 142 coated on at least one surface of the current collectors 123 and 143.

The positive electrode layer 120 may be formed by coating the positive electrode active material layers 121 and 122 on at least one surface of the positive electrode current collector 123, and the negative electrode layer 140 may be formed by coating the negative electrode active material layers 141 and 142 on at least one surface of the negative electrode current collector 143. For example, the uppermost electrode layer in the stacking direction may be formed by coating the positive electrode active material layer 122 on one surface of the positive electrode current collector 123, and the lowermost electrode layer may be formed by coating the negative electrode active material layer 141 on one surface of the negative electrode current collector 143. In addition, the electrode layers between the uppermost and lowermost ends are formed by coating the positive electrode active material layers 121 and 122 on both surfaces of the positive electrode current collector 123, or by coating the negative electrode active material layers 141 and 142 on both surfaces of the negative electrode current collector 143.

The positive electrode active material layers 121 and 122 may include a positive electrode active material and, optionally, a solid electrolyte. In addition, the positive electrode active material layers 121 and 122 may optionally further include an additive such as a binder or a conductive agent.

For example, the positive electrode active material is not particularly limited as long as it can secure sufficient capacity of the all-solid-state battery 100. For example, the positive electrode active material may include lithium cobalt oxide, lithium nickel cobalt manganese oxide, lithium nickel cobalt aluminum oxide, lithium iron phosphate, lithium manganese oxide, or a combination thereof.

For example, the positive electrode active material may be compounds represented by the following chemical formulas: LiₐA_{1-b}M_{b}D₂ (wherein 0.90≤a≤1.8, 0≤b≤0.5); LiₐE_{1-b}M_{b}O_{2-c}D_{c} (wherein 0.90≤a≤1.8, 0≤b≤0.5, 0≤c≤0.05); LiE_{2-b}M_{b}O_{4-c}D_{c} (wherein 0≤b≤0.5, 0≤c≤0.05); LiₐNi_{1-b-c}Co_{b}M_{c}D_{α} (wherein 0.90≤a≤1.8, 0≤b≤0.5, 0≤c≤0.05, 0<α≤2); LiₐNi_{1-b-c}Co_{b}M_{c}O_{2-α}X_{α} (wherein 0.90≤a≤1.8, 0≤b≤0.5, 0≤c≤0.05, 0<α<2); LiₐNi_{1-b-c}CO_{b}M_{c}O_{2-α}X₂ (wherein 0.90≤a≤1.8, 0≤b≤0.5, 0≤c≤0.05, 0<α<2); LiₐNi_{1-b-c}Mn_{b}M_{c}D_{α} (wherein 0.90≤a≤1.8, 0≤b≤0.5, 0≤c≤0.05, 0<α≤2); LiₐNi_{1-b-c}Mn_{b}M_{c}O_{2-α}X_{α} (wherein 0.90≤a≤1.8, 0≤b≤0.5, 0≤c≤0.05, 0<α<2); LiₐNi_{1-b-c}Mn_{b}M_{c}O_{2-α}X₂ (wherein 0.90≤a≤1.8, 0≤b≤0.5, 0≤c≤0.05, 0<α<2); LiₐNi_{b}E_{c}G_{d}O₂ (wherein 0.90≤a≤1.8, 0≤b≤0.9, 0≤c≤0.5, 0.001≤d≤0.1); LiₐNi_{b}Co_{c}Mn_{d}GeO₂ (wherein 0.90≤a≤1.8, 0≤b≤0.9, 0≤c≤0.5, 0≤d≤0.5, 0.001≤e≤0.1); LiₐNiGbO₂ (wherein 0.90≤a≤1.8, 0.001≤b≤0.1); LiₐCoGbO₂ (wherein 0.90≤a≤1.8, 0.001≤b≤0.1); LiₐMnGbO₂ (wherein 0.90≤a≤1.8, 0.001≤b≤0.1); LiₐMn₂GbO₄ (wherein 0.90≤a≤1.8, 0.001≤b≤0.1); QO₂; QS₂; LiQS₂; V₂O₅; LiV₂O₂; LiRO₂; LiNiVO₄; Li_{(3-f)}J₂(PO₄)₃ (0≤f≤2); Li_{(3-f)}Fe₂(PO₄)₃ (wherein 0≤f≤2); and LiFePO₄, wherein in the above chemical formulas, A is Ni, Co, or Mn; M is Al, Ni, Co, Mn, Cr, Fe, Mg, Sr, V, or a rare-earth element; D is O, F, S, or P; E is Co or Mn; X is F, S, or P; G is Al, Cr, Mn, Fe, Mg, La, Cc, Sr, or V; Q is Ti, Mo, or Mn; R is Cr, V, Fe, Sc, or Y; and J is V, Cr, Mn, Co, Ni, or Cu.

The positive electrode active material may also be LiCoO₂, LiMnₓO₂ₓ (wherein x=1 or 2), LiNi₁₋ₓMnₓO₂ₓ (wherein 0<x<1), LiNi_{1-x-y}CoₓMn_{y}O₂ (wherein 0≤x≤0.5 and 0≤y≤0.5), LiFePO₄, TiS₂, FeS₂, TiS₃, or FeS₃.

The solid electrolyte may be a solid electrolyte usable in the solid electrolyte layer 130 described later. The solid electrolyte may function as an ion conduction channel in the positive electrode layer 120, and through this, interface resistance may be reduced.

A content of the solid electrolyte may be greater than or equal to 0.1 pans by weight, greater than or equal to 1 part by weight, or greater than or equal to 10 parts by weight, and less than or equal to 80 parts by weight, less than or equal to 60 parts by weight, or less than or equal to 50 parts by weight, based on 100 parts by weight of the total amount of the positive electrode active material.

The conductive agent is not particularly limited as long as it has conductivity without causing chemical change in the all-solid-state battery 100. For example, examples of the conductive agent may include: graphite such as natural graphite and artificial graphite; carbon-based substances such as carbon black, acetylene black, ketjen black, channel black, furnace black, lamp black, and summer black; conductive fibers such as carbon fibers and metal fibers; fluorinated carbon; metal powders such as aluminum and nickel powder; conductive whiskers such as zinc oxide and potassium titanate; conductive metal oxides such as titanium oxide; or conductive materials such as polyphenylene derivatives.

A content of the conductive agent may be 1 part by weight to 10 parts by weight, for example, 2 parts by weight to 5 parts by weight, based on 100 parts by weight of the positive electrode active material. When the content of the conductive agent is within the above range, a finally obtained electrode may have excellent conductivity characteristics.

The binder may be used to improve bonding strength between an active material and a conductive agent. The binder may include polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene terpolymer (EPDM), sulfonated EPDM, a styrene butadiene rubber, a fluororubber, or various copolymers, and the like.

A content of the binder may be 1 part by weight to 50 parts by weight, for example, 2 parts by weight to 5 parts by weight, based on 100 parts by weight of the total positive electrode active material. When the content of the binder satisfies the above range, the active material layer may have high bonding strength.

As the positive electrode current collector 123, a porous material such as a mesh or mesh shape may be used, and a porous metal plate such as stainless steel, nickel, or aluminum may be used. In addition, the positive electrode current collector 123 may be coated with an oxidation-resistant metal or alloy film to prevent oxidation.

The negative electrode active material layers 141 and 142 may include a negative electrode active material and, optionally, a solid electrolyte. In addition, the negative electrode active material layers 141 and 142 may optionally further include an additive such as a binder or a conductive agent.

The negative electrode active material may be a carbon-based material, silicon, a silicon oxide, a silicon-based alloy, a silicon-carbon-based material composite, tin, a tin-based alloy, a tin-carbon composite, a metal oxide, or a combination thereof, and may include a lithium metal and/or a lithium metal alloy.

The lithium metal alloy may include lithium and a metal/semi-metal capable of alloying with lithium. For example, the metal/semi-metal capable of alloying with lithium may include Si, Sn, Al, Ge, Pb, Bi, Sb, a Si—Y alloy (wherein Y is an alkali metal, an alkaline-earth metal, Group 13 to Group 16 elements, a transition metal, a rare earth element, or a combination thereof, and Si is not included), a Sn—Y alloy (wherein Y is an alkali metal, an alkaline earth metal, Group 13 to Group 16 elements, a transition metal, or a transition metal oxide such as lithium titanium oxide (Li₄Ti₅O₁₂), a rare earth element, or a combination thereof, and Sn is not included), or M_{α}Oₓ (0<x≤2).

The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Sc, Te, Po, or a combination thereof.

In addition, the oxide of a metal/semi-metal capable of alloying with lithium may be lithium titanium oxide, vanadium oxide, lithium vanadium oxide, SnO₂, SiOₓ (0<x<2), and the like. For example, the negative electrode active material may include one or more elements selected from elements of Groups 13 to 16 of the periodic table of elements. For example, the negative electrode active material may include one or more elements selected from the group consisting of Si, Ge, and Sn.

The carbon-based material may be crystalline carbon, amorphous carbon, or mixtures thereof. The crystalline carbon may include graphite, such as natural graphite or artificial graphite in amorphous, plate, flake, spherical, or fibrous form. In addition, the amorphous carbon may include soft carbon (low temperature calcined carbon) or hard carbon, a mesophase pitch carbonization product, calcined coke, graphene, carbon black, fullerene soot, carbon nanotubes, carbon fiber, and the like.

The silicon may be Si, SiOₓ (0<x<2, for example 0.5 to 1.5), Sn, SnO₂, a silicon-containing metal alloy, or a mixture thereof. The silicon-containing metal alloy may include, for example, silicon and one or more of Al, Sn, Ag, Fe, Bi, Mg, Zn, In, Ge, Pb, and Ti.

The solid electrolyte may be a solid electrolyte usable in the solid electrolyte layer 130 described later. The solid electrolyte may function as an ion conduction channel in the negative electrode layer 140, and through this, interface resistance may be reduced.

A content of the solid electrolyte may be greater than or equal to 0.1 parts by weight, greater than or equal to 1 part by weight, or less than or equal to 10 parts by weight, less than or equal to 80 parts by weight, less than or equal to 60 parts by weight, or less than or equal to 50 parts by weight based on 100 parts by weight of the total amount of the negative electrode active material.

The negative electrode active material layers 141 and 142 may also optionally include a conductive agent and a binder as described for the positive electrode active material layers 121 and 122.

The negative electrode current collector 143 may be a mesh or mesh-shaped porous body, and a porous metal plate such as stainless steel, nickel, or aluminum. In addition, the negative electrode current collector 143 may be coated with an oxidation-resistant metal or alloy film to prevent oxidation.

The solid electrolyte layer 130 may be interposed and slacked between the positive electrode layer 120 and the negative electrode layer 140. Therefore, the solid electrolyte layer 130 may be adjacently disposed between the positive electrode active material layers 121 and 122 of the positive electrode layer 120 and the negative electrode active material layers 141 and 142 of the negative electrode layer 140 in the stacking direction. Therefore, in the all-solid-state battery 100, a plurality of positive electrode layers 120 and a plurality of negative electrode layers 140 may be alternately disposed, and a plurality of solid electrolyte layers 130 may be interposed and stacked therebetween. The all-solid-state battery 100 is a stacked all-solid-state battery 100 manufactured by alternately stacking a plurality of positive electrode layers 120 and negative electrode layers 140, and interposing a plurality of solid electrolyte layers 130 therebetween to provide a cell stack, and then firing them collectively.

The solid electrolyte layer 130 may include an inorganic solid electrolyte including an oxide-based solid electrolyte, a sulfide-based solid electrolyte, or a combination thereof.

The oxide-based solid electrolyte may be a garnet-type, NASICON-type, LISICON-type, perovskite-type, LiPON-type, or amorphous (glass) electrolyte.

The garnet-based solid electrolyte may include lithium-lanthanum zirconium oxide (LLZO) represented by LiₐLa_{b}Zr_{c}O₁₂ such as Li₇La₃Zr₂O₁₂, and the NASICON-based solid electrolyte may include a lithium-aluminum-titanium-phosphate salt (LATP) of Li₁₊ₓAlₓTi₂₋ₓ(PO₄)₃ (0<x<1) in which Ti is introduced into a Li₁₊ₓAlₓM₂₋ₓ(PO₄)₃ (LAMP) (0<x<2, M is Zr, Ti, or Ge) type compound, lithium-aluminum-germanium-phosphate (LAGP) represented by Li₁₊ₓAlₓGe₂₋ₓ(PO₄)₃ (0<x<1) such as Li_{1.3}Al_{0.3}Ti_{1.7}(PO₄)₃ introduced with excess lithium and/or lithium-zirconium-phosphate (LZP) of LiZr₂(PO₄)₃.

In addition, the LISICON-based solid electrolyte may include a solid solution oxide represented by xLi₃AO₄-(1−x)Li₄BO₄ (wherein A is P, As, or V and B is Si, Ge, or Ti) such as Li₄Zn(GeO₄)₄, Li₁₀GeP₂O₁₂ (LGPO), Li_{3.5}Si_{0.5}P_{0.5}O₄, or Li_{10.42}Si(Ge)_{1.5}P_{1.5}Cl_{0.08}O_{11.92}, or a solid solution sulfide represented by Li₄₋ₓM_{1-y}M′_{y}S₄ (wherein M is Si, or Ge and M′ is P, Al, Zn, or Ga) such as Li₂S—P₂S₅, Li₂S—SiS₂, Li₂S—SiS₂—P₂S₅, or Li₂S—GeS₂.

The perovskite-based solid electrolyte may include lithium lanthanum titanate (LLTO) represented by Li₃ₓLa_{2/3-x} [symbol] _{1/3-2x}TiO₃ (0<x<0.16, [symbol] : vacancy) such as Li_{1/8}La_{5/8}TiO₃. The LiPON-based solid electrolyte may include a phosphorous oxynitride such as Li_{2.8}PO_{3.3}N_{0.46}.

Examples of the amorphous electrolyte include Li₂O—B₂O₃—SiO₂, Li₂O—B₂O₃—P₂O₅, Li₃BO₃—Li₂SO₄, or Li₃BO₃—Li₂CO₃.

For example, the oxide-based solid electrolyte may include glass or glass ceramic, which is a lithium ion conductor, and may include glass ceramic so that lithium (Li) ion conductivity may be further improved. When the solid electrolyte layer 130 includes glass or glass ceramic, the stability of the solid electrolyte layer 130 against atmospheric moisture may be improved.

Herein, the glass refers to a crystallographically amorphous material in which a halo is observed in X-ray diffraction, electron beam diffraction, or the like. The glass ceramic (or crystallized glass) refers to a mixture of amorphous and crystalline crystals in which a peak and a halo are observed in the X-ray diffraction, the electron beam diffraction, or the like.

The solid electrolyte may have lithium (Li) ionic conductivity of greater than or equal to greater than or equal to 1.0×10⁷ S/cm in terms of performance improvement of the all-solid-state battery 100. The lithium (Li) ionic conductivity of the solid electrolyte is equally measured to the method of measuring the lithium (Li) ionic conductivity of the margin layer 150 or the cover layer 160 except that a sample for the measurement is prepared by exposing the solid electrolyte layer 130 through ion milling, polishing, or the like in the all-solid-state battery 100 and using it.

The glass or the glass ceramic included in the solid electrolyte layer 130 may be sintered. The sintering of the glass or glass ceramic may be performed at less than or equal to 550° C., for example, 300° C. to 550° C., or 300° C. to 500° C.

When the sintering of the glass or glass ceramic is performed at less than or equal to 550° C., since loss of a carbon material is suppressed during the sintering process, the carbon material may be used as a negative electrode active material, additionally improving energy density of the all-solid-state battery 100. In addition, when the positive electrode active material layers 121 and 122 include a conductive agent, the carbon material may be used as the conductive agent to form a good electron conduction path in the positive electrode active material layers 121 and 122, improving conductivity of the positive electrode active material layers 121 and 122. In addition, even when the negative electrode active material layers 141 and 142 include the conductive agent, the carbon material may be used as the conductive agent, improving conductivity of the negative electrode active material layers 141 and 142.

When the sintering temperature of the glass or the glass ceramic is greater than 550° C., the solid electrolyte reacts with the electrode active materials during the sintering process, forming byproducts and thus deteriorating characteristics of the all-solid-state battery 100. In addition, when the sintering temperature is less than or equal to 550° C., which corresponds to low-temperature sintering, types of the electrode active materials may be selected within a wider range, improving design freedom of the all-solid-state battery 100.

When the sintering temperature of the glass or the glass ceramic is greater than or equal to 300° C. an organic binder such as an acryl resin and the like, which may be included in an electrode precursor and/or a precursor of the solid electrolyte layer 130 during the sintering process, may be lost.

The glass or glass ceramic may include lithium (Li) oxide and lithium chloride (LiCl), respectively.

The glass or the glass ceramic including lithium (Li) oxide has a sintering temperature of less than or equal to 550° C., high heat shrinkage, and excellent fluidity. Accordingly, reactions between the solid electrolyte layer 130 and the positive electrode active material layers 121 and 122 and between the solid electrolyte layer 130 and the negative electrode active material layers 141 and 142 may be suppressed. In addition, interface resistance may be reduced by forming satisfactory interfaces between the positive electrode active material layers 121 and 122 and the solid electrolyte layer 130 and between the negative electrode active material layers 141 and 142 and the solid electrolyte layer 130.

In addition, when the glass or glass ceramic includes lithium chloride (LiCl), a battery having high ionic conductivity performance of greater than or equal to 1.0×10⁶ S/cm may be manufactured.

The glass or glass ceramic may further include silicon (Si) oxide, boron (B) oxide, phosphorus (P) oxide, germanium (Ge) oxide, or a combination thereof. The glass or glass ceramic further including silicon (Si) oxide, boron (B) oxide, phosphorus (P) oxide, germanium (Ge) oxide, or a combination thereof in addition to lithium (Li) oxide and lithium chloride (LiCl) has a sintering temperature of 300° C. to 550° C., high heat shrinkage, and excellent fluidity, resultantly reducing interface resistance and thus improving energy density of the all-solid-state battery 100.

In order to decrease the sintering temperature of the solid electrolyte, a content of lithium (Li) oxide (Li₂O) may be 20 mol % to 75 mol %, for example, 30 mol % to 75 mol %, 40 mol % to 75 mol %, or 50 mol % to 75 mol % based on the total amount of the glass or glass ceramic.

A content of lithium chloride (LiCl) based on the total content of the glass or glass ceramic may be 3 mol % to 22 mol %, for example, 3 mol % to 6 mol %, or 18 mol % to 22 mol %. When the content of lithium chloride (LiCl) is less than 3 mol %, high ionic conductivity performance may be difficult to secure, and when greater than 22 mol %, deliquescence may be deteriorated.

When the glass or glass ceramic further includes silicon (Si) oxide (SiO₂), a content of the silicon (Si) oxide may be 0 mol % to 70 mol % based on the total amount of the glass or glass ceramic, for example, 0 mol % to 12 mol %, or 15 mol % to 30 mol %.

When the glass or glass ceramic further includes boron (B) oxide (B₂O₃), the content of the boron (B) oxide may be 0 mol % to 60 mol %, based on the total amount of the glass or glass ceramic, for example, 5 mol % to 15 mol %, or 17 mol % to 35 mol %.

When the glass or glass ceramic further includes phosphorus (P) oxide (P₂O₅), the content of the phosphorus (P) oxide may be 0 mol % to 50 mol %, based on the total amount of the glass or glass ceramic, for example, 8 mol % to 17 mol %, or 20 mol % to 40 mol %.

When the glass or glass ceramic further includes germanium (Ge) oxide (GeO₂), a content of the germanium (Ge) oxide may be 0 mol % to 80 mol %, based on the total amount of the glass or glass ceramic, for example, 0 mol % to 3 mol %, or 5 mol % to 8 mol %.

The content of each oxide is a content of each oxide in the glass or glass ceramic, for example, a content (mol) ratio of each oxide, based on the total content (mol) of lithium (Li) oxide, lithium chloride (LiCl), silicon (Si) oxide, boron (B) oxide, phosphorus (P) oxide, and germanium (Ge) oxide, which is expressed as a percentage (mol %). The content of each oxide may be measured by using inductively-coupled plasma light emission spectrometry (ICP-AES) or the like.

The glass or glass ceramic may further include an additive element as needed. Examples of the additional element may include Na (sodium), Mg (magnesium), Al (aluminum), K (potassium), Ca (calcium), Ti (titanium), V (vanadium), Cr (chromium), Mn (manganese), Fe (iron), Co (cobalt), Ni (nickel), Cu (copper), Zn (zinc), Ga (gallium), Se (selenium), Rb (rubidium), S (sulfur), Y (yttrium), Zr (zirconium), Nb (niobium), Mo (molybdenum), Ag (silver), In (indium), Sn (tin), Sb (antimony), Cs (cesium), Ba (vanadium), Hf (hafnium), Ta (tantalum), W (tungsten), Pb (lead), Bi (bismuth), Au (gold), La (lanthanum), Nd (neodymium), Eu (europium), or a combination thereof. The glass or glass ceramic may include at least one selected from these additional elements as an oxide.

The glass or glass ceramic included in the solid electrolyte layer 130 may have ionic conductivity of greater than or equal to 1×10⁻³ S/cm. The ionic conductivity may be measured at a temperature of 25° C. The ionic conductivity may be greater than or equal to 1×10⁻³ S/cm, greater than or equal to 2×10⁻³ S/cm, greater than or equal to 3×10⁻³ S/cm, greater than or equal to 4×10⁻³ S/cm, or greater than or equal to 5×10⁻³ S/cm, of which an upper limit is not particularly limited. When a solid electrolyte satisfying the ranges of ionic conductivity is used, the all-solid-state battery 100 may exhibit high output.

The margin layer 150 may be disposed along edges of the positive electrode layer 120 and the negative electrode layer 140. The margin layer 150 may be disposed on the solid electrolyte layer 130 and may be formed laterally adjacent to edges of the positive electrode active material layers 121 and 122 or the negative electrode active material layers 141 and 142. Accordingly, the margin layer 150 may be disposed on the same layer as the positive electrode layer 120 and the negative electrode layer 140.

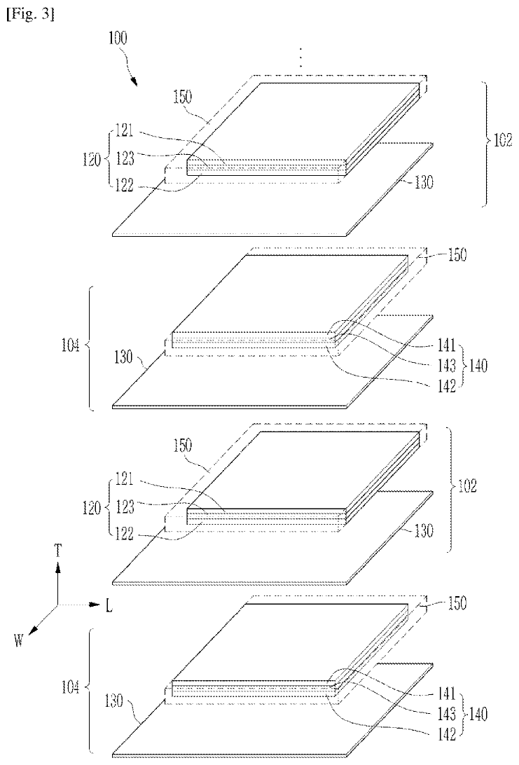

FIG. 3 is an exploded perspective view schematically illustrating a cell stack structure of the all-solid-state battery 100 according to the embodiment shown in FIG. 1.

Referring to FIG. 3, the positive electrode layer 120 and the margin layer 150 stacked on the solid electrolyte layer 130 in the present embodiment forms one positive electrode unit 102, and the negative electrode layer 140 and the margin layer 150 stacked on another solid electrolyte layer 130 may form one negative electrode unit 104. A plurality of the positive electrode units 102 and the negative electrode units 104 are alternately stacked and combined, forming a cell stack of the all-solid-state battery 100 according to the present embodiment.

Specifically, the positive electrode unit 102 may be configured to sequentially stack the positive electrode active material layer 121, the positive electrode current collector 123, and the positive electrode active material layer 122 on the solid electrolyte layer 130 and form the margin layer 150 to surround edges of the positive electrode active material layers 121 and 122 and the positive electrode current collector 123 on the same layer as the positive electrode active material layers 121 and 122 and the positive electrode current collector 123.

In addition, the negative electrode unit 104 may be configured to sequentially stack the negative electrode active material layer 142, the negative electrode current collector 143, and the negative electrode active material layer 141 on the solid electrolyte layer 130 and form the margin layer 150 to surround edges of the negative electrode active material layers 141 and 142 and the negative electrode current collector 143 on the same layer as the negative electrode active material layers 141 and 142 and the negative electrode current collector 143.

The positive electrode layer 120, the solid electrolyte layer 130, the negative electrode layer 140, and the margin layer 150 are stacked as described above to configure the cell stack of the all-solid-state battery 100, and on the outer surface of the cell stack of the all-solid-state battery 100, a cover layer 160 is disposed.

For example, the cover layer 160 may surround the surface of the cell stack, so that one end of the positive electrode layer 120 may be exposed to (or be in contact with or extend from) a first surface of the cell stack and connected to one external electrode 112, while one end of the negative electrode layer 140 is exposed to (or be in contact with or extend from) a second surface of the cell stack and connected to the other external electrode 114, for example, may be disposed on third and fourth surfaces of the cell stack except for the first and second surfaces of the cell stack or on the outer surfaces of the electrode layer 120 at the top in the stacking direction of the cell stack and the negative electrode layer 140 at the bottom. Herein, the solid electrolyte layer 130 may be disposed between the cover layer 160 and its adjacent positive electrode layer 120 or negative electrode layer 140.

The margin layer 150 and/or the cover layer 160 include glass or glass ceramic. By surrounding the surface of the all-solid-state battery 100 with the margin layer 150 and/or the cover layer 160 including these materials, moisture permeation into the all-solid-state battery 100 may be suppressed. Accordingly, moisture-proof properties of the all-solid-state battery 100 can be improved.

The glass or glass ceramic included in the margin layer 150 and/or the cover layer 160 may include lithium fluoride (LiF).

The lithium fluoride (LiF), compared with lithium chloride (LiCl), has high density and low water solubility and is insoluble and accordingly, is effective in preventing penetration of external moisture. In addition, the lithium fluoride (LiF) has low ionic conductivity and equal heat shrinkage density, compared with the lithium chloride (LiCl) under firing conditions of 450° C. to 500° C.

In other words, the lithium fluoride (LiF) has low ionic conductivity, high impedance resistance, and low electronic conductivity, when the cover layer 160 and/or margin layer 150 includes glass or glass ceramic including the lithium fluoride (LiF), and thus may effectively prevent the penetration of external moisture and thus exhibit an excellent moisture-proof function and in addition, has excellent insulating properties and thus may prevent defects of the all-solid-state battery 100 due to the deposition of lithium (Li) ion precipitates on a negative electrode during the operation of the all-solid-state battery 100, improving reliability of the all-solid-state battery 100.

The glass or glass ceramic included in the margin layer 150 and/or the cover layer 160 may further include lithium (Li) oxide, silicon (Si) oxide, boron (B) oxide, phosphorus (P) oxide, germanium (Ge) oxide, or a combination thereof. The glass or glass ceramic including lithium (Li) oxide, silicon (Si) oxide, boron (B) oxide, phosphorus (P) oxide, germanium (Ge) oxide, or a combination thereof along with lithium fluoride (LiF) has a sintering temperature of 300° C. to 550° C., high heat shrinkage, and excellent fluidity, reducing interface resistance and improving energy density of the all-solid-state battery 100.

A content of the lithium fluoride (LiF) may be 5 mol % to 15 mol %, for example, 5 mol % to 10 mol %, or 10 mol % to 15 mol % based on the total amount of the glass or glass ceramic. When the content of the lithium fluoride (LiF) is less than 5 mol %, the sintering temperature characteristics may be deteriorated, and when the content of the lithium fluoride (LiF) is greater than 15 mol %, loss of clarity may occur.

The content of lithium (Li) oxide (Li₂O) may be 20 mol % to 75 mol %, for example, 30 mol % to 75 mol %, 40 mol % to 75 mol %, or 50 mol % to 75 mol % based on the total amount of the glass or glass ceramic in order to reduce the sintering temperature of the solid electrolyte.

When the glass or glass ceramic further include silicon (Si) oxide (SiO₂), a content of the silicon (Si) oxide may be 0 mol % to 70 mol %, for example, 0 mol % to 12 mol %, or 15 mol % to 30 mol % based on the total amount of the glass or glass ceramic.

When the glass or glass ceramic further includes boron (B) oxide (B₂,O), the content of the boron (B) oxide may be 0 mol % to 60 mol %, for example, 5 mol % to 15 mol %, or 17 mol % to 35 mol % based on the total amount of the glass or glass ceramic.

When the glass or glass ceramic further includes phosphorus (P) oxide (P₂O₅), the content of the phosphorus (P) oxide may be 0 mol % to 50 mol %, for example, 8 mol % to 17 mol %, or 20 mol % to 40 mol % based on the total amount of the glass or glass ceramic.

When the glass or glass ceramic further includes germanium (Ge) oxide (GeO₂), a content of the germanium (Ge) oxide may be 0 mol % to 80 mol %, for example, 0 mol % to 3 mol %, or 5 mol % to 8 mol % based on the total amount of the glass or glass ceramic.

The content of each oxide is a content of each oxide in the glass or glass ceramic, for example, a content (mol) ratio of each oxide based on the total amount (mol) of lithium fluoride (LiF), lithium (Li) oxide, silicon (Si) oxide, boron (B) oxide, phosphorus (P) oxide, and germanium (Ge) oxide, which is expressed as a percentage (mol %). The content of each oxide may be measured by using inductively coupled plasma light emitting spectrometry (ICP-AES) or the like.

The glass or glass ceramic may further include an additive element as needed. Examples of the additional element may include Na (sodium), Mg (magnesium), Al (aluminum), K (potassium), Ca (calcium), Ti (titanium), V (vanadium), Cr (chromium), Mn (manganese), Fe (iron), Co (cobalt), Ni (nickel), Cu (copper), Zn (zinc), Ga (gallium), Se (selenium), Rb (rubidium), S (sulfur), Y (yttrium)), Zr (zirconium), Nb (niobium), Mo (molybdenum), Ag (silver), In (indium), Sn (tin), Sb (antimony), Cs (ccsium), Ba (vanadium), Hf (hafnium), Ta (tantalum), W (tungsten), Pb (lead), Bi (bismuth), Au (gold), La (lanthanum), Nd (neodymium), Eu (europium), or a combination thereof. The glass or glass ceramic may include at least one selected from these additional elements as an oxide.

The margin layer 150 or cover layer 160 may have moisture transmittance of less than or equal to 1 g/m²/day, for example, less than or equal to 0.75 g/m²/day, or less than or equal to 0.5 g/m²/day in order to improve moisture-proof properties of the all-solid-state battery 100. The moisture transmittance of the margin layer 150 or cover layer 160 may be measured as follows. First of all, a portion of the margin layer 150 or cover layer 160 is sampled as a rectangular plate piece by ion-milling or polishing in the all-solid-state battery 100. Subsequently, the margin layer 150 or cover layer 160 is measured with respect to aqueous vapor transmittance (23° C., RH of 90%) in accordance with JIS K7129-C (ISO 15106-4).

The margin layer 150 or cover layer 160 may have lithium (Li) ionic conductivity of less than or equal to 1.0×10⁻⁸ S/cm, for example, less than or equal to 1.0×10⁻¹⁰ S/cm in order to prevent self-discharge of the all-solid-state battery 100.

The lithium (Li) ionic conductivity of the margin layer 150 or cover layer 160 may be measured in an AC impedance method. First of all, a portion of the margin layer 150 or cover layer 160 is sampled as a rectangular plate piece in the all-solid-state battery 100 by ion milling, polishing, or the like. Subsequently, an electrode made of gold (Au) is formed at both ends of the obtained piece, obtaining a sample. Then, an impedance-measuring device is used to measure AC impedance (frequency: 10⁺⁶ Hz to 10⁻¹ Hz, voltage: 100 mV, 1000 mV) of the sample at mom temperature (25° C.) and then, the ionic conductivity is calculated.

The electrical conductivity of the margin layer 150 or cover layer 160 may be less than or equal to 1.0×10⁻⁸ S/cm, for example, less than or equal to 1.0×10⁻¹⁰ S/cm to prevent self-discharge of the all-solid-state battery 100.

The electrical conductivity of the margin layer 150 or cover layer 160 is obtained by preparing a sample in the same method as the method of measuring the lithium (Li) ionic conductivity and using the sample at room temperature (25° C.) in a 2-terminal method.

An average thickness of the cover layer 160 may be less than or equal to 50 μm, for example, less than or equal to 40 μm, or less than or equal to 30 μm to improve energy density of the all-solid-state battery 100. The average thickness of the cover layer 160 may be measured in the following method. First of all, a cross-section of the cover layer 160 is prepared by ion-milling and the like, and a cross-section scanning electron microscope (SEM) photograph thereof is taken. Subsequently, in the cross-sectional SEM photograph, 10 points are randomly picked, and a thickness of the cover layer 160 at each point is measured and averaged to obtain an arithmetic mean as the average thickness of the cover layer 160.

As described above, terminals of the positive electrode current collector 123 and the negative electrode current collector 143 are exposed onto (or are in contact with or extend from) both sides of the cell stack of the all-solid-state battery 100, and the external electrodes 112 and 114 are connected to the exposed terminals and combined therewith. In other words, the external electrodes 112 and 114 are connected to the terminal of the positive electrode current collector 123 to form a positive electrode and also, connected to the terminal of the negative electrode current collector 143 to form a negative electrode. When the terminals of the positive electrode current collector 123 and the negative electrode current collector 143 are configured to face in opposite directions from each other, the external electrodes 112 and 114 may also be positioned at both sides, respectively.

Herein, the external electrodes 112 and 114 may cover sides of the cover layer 160 as well as the cell stack. In other words, the cover layer 160 is formed by firing all collectively when the cell stack is manufactured, and subsequently, as the external electrodes 112 and 114 are formed, the external electrodes 112 and 114 may also be located at the sides of the cover layer 160. In this point of view, the cover layer 160 is distinguished from a protective layer which is formed after forming the external electrodes 112 and 114.

The protective layer is disposed on the outside of the cover layer 160 but covers a band portion extended toward a first side or a second side of the protective layer, and the external electrodes 112 and 114 may not be positioned on the sides of the protective layer. The protective layer may include an insulating material such as a polyolefin such as polyethylene, polypropylene, and the like, a polyester such as polyethylene terephthalate (PET) and the like, polyurethane, polyimide, or the like, for example, a fluorine-based polymer resin.

The external electrodes 112 and 114 may include a conductive metal and glass.

The conductive metal may include, for example, copper (Cu), nickel (Ni), (in (Sn), palladium (Pd), platinum (Pt), gold (Au), silver (Ag), tungsten (W), titanium (Ti), lead (Pb), or an alloy thereof.

A glass component included in the first and second external electrodes 112 and 114 may have a composition in which an oxide is mixed. The glass component may include, for example, a silicon oxide, a boron oxide, an aluminum oxide, a transition metal oxide, an alkali metal oxide, an alkaline-earth metal oxide, or a combination thereof. Herein, the transition metal may be selected from zinc (Zn), titanium (Ti), copper (Cu), vanadium (N), manganese (Mn), iron (Fe), or nickel (Ni), the alkali metal may be selected from lithium (Li), sodium (Na), or potassium (K), and the alkaline-earth metal may be selected from magnesium (Mg), calcium (Ca), strontium (Sr), or barium (Ba).

A method of forming the first and second external electrodes 112 and 114 is not particularly limited. For example, the method may include dipping the cell stack in a conductive paste including a conductive metal and glass or screen-printing or gravure-printing the conductive paste on the surface of the cell stack. In addition, various methods of applying the conductive paste on the surface of the cell stack or transferring a dry film obtained by drying the conductive paste onto the cell stack may be used.

### MODE FOR THE INVENTION

Hereinafter, specific examples of the invention are presented. However, the examples described below are only intended to specifically illustrate or explain the invention, and the scope of the invention should not be limited thereto.

A glass frit having a composition shown in Table 1 is prepared and fired at 450° C. to 500° C., preparing each glass or glass ceramic for a cover layer according to examples and comparative examples.

The prepared glass or glass ceramic of a cover layer is measured with respect to lithium ionic conductivity, heat shrinkage density, and water resistance, and the results are shown in Table 1.

The lithium ionic conductivity is measured in an AC impedance method. For example, a sample is prepared by forming an electrode formed of gold (Au) at both sides of the prepared glass or glass ceramic sample and then measuring it with respect to AC impedance (frequency: 10⁺⁶ Hz to 10⁻¹ Hz, voltage: 100 mV, 1000 mV) by using an impedance-measuring device at room temperature (25° C.) to calculate ionic conductivity.

The heat shrinkage density is calculated by measuring an exact volume and weight in an apparent density measurement method. For example, the heat shrinkage density may be obtained by measuring a diameter, a thickness, and a weight of a circular pellet, and then calculating [weight]/[(thickness/10)×(diameter/20)]²×3.141592.

The water resistance (WVTR) is evaluated by measuring aqueous vapor transmittance (23° C., RH of 90%) of the glass or glass ceramic sample according to JIS K7129-C (ISO 15106-4).

TABLE 1

| | | Example | Comparative Example |
|---|---|---|---|
| Composition | LiF | 10 | 0 |
| (mol %) | LiCl | 0 | 4 |
| | Li₂O | 30 | 43 |
| | SiO₂ | 11 | 11 |
| | B₂O₃ | 45 | 38 |
| | P₂O₅ | 1 | 1 |
| | GeO₂ | 3 | 3 |
| | Sum | 100 | 100 |

| | | |
|---|---|---|
| Lithium ionic conductivity (S/cm) | <1.0E−10 | ≥1.0E−05 |
| Heat shrinkage density (g/cm³) | 2.26 | 2.25 |
| Water resistance (g/m²/day) | 1.5 | — |

The lithium chloride (LiCl) used in the comparative example has a boiling point (b.p) of 1382° C., a melting point (m.p) of 605° C. to 614° C., density (g/cm³) of 2.068, a molecular weight (g/mol) of 43.39, water solubility (g/L) (25° C.) of 84.3 g/100 mL and thus is water-soluble, and ethanol solubility (g/1100 g) (25° C.) of 24.28. On the other hand, the lithium fluoride (LiF) used in the examples has a boiling point (b.p.) of 1676° C., a melting point (m.p) of 845° C., density (g/cm³) of 2.64, a molecular weight (g/mol) of 25.949, and water solubility (g/L) (25° C.) of 0.134 g/100 mL and thus is insoluble.

In addition, the glass or glass ceramic prepared in the examples has an opaque appearance, a specific gravity of 2.1, hardness of 5.5, a glass transition temperature (° C.) of 410° C. to 425° C., a softening point (° C.) of 430° C. to 450° C. a crystallization temperature (° C.) of 495° C., a mass reduction-starting temperature (° C.) of 120° C., a thermal expansion coefficient (1/° C.) of 0.7×10⁻⁵ to 9×10⁻⁵, and firing shrinkage (%) of 92.

Accordingly, the lithium fluoride (LiF), compared with lithium chloride (LiCl), has high density and low water solubility and thus is insoluble and accordingly, effectively prevents the external moisture penetration. In addition, the lithium fluoride (LiF) has low ionic conductivity and the same heat shrinkage density as the lithium chloride (LiCl) under firing conditions of 450° C. to 500° C.

In other words, since the lithium fluoride (LiF) has low ionic conductivity, high impedance resistance, and low electronic conductivity, when the cover layer or margin layer includes the glass or glass ceramic including the lithium fluoride (LiF), an all-solid-state battery may be effectively prevented from penetration of external moisture to secure an excellent moisture-proof function, and in addition, from battery defects due to the deposition of lithium (Li) ion precipitates on a negative electrode during operation of the all-solid-state battery to improve battery reliability.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

100: all-solid-state battery
102: positive electrode unit
104: negative electrode unit
112, 114: external electrode
120: positive electrode layer
121, 122: positive electrode active material layer
123: positive electrode current collector
130: solid electrolyte layer
140: negative electrode layer
141, 142: negative electrode active material layer
143: negative electrode current collector
150: margin layer
160: cover layer

### INDUSTRIAL APPLICABILITY

The present disclosure relates to an all-solid-state battery with improved reliability by effectively preventing the penetration of external moisture and having excellent moisture-proof functions and excellent insulation properties to prevent battery failure due to the deposition of lithium (Li) ion precipitates on the negative electrode during battery operation.

1. An all-solid-state battery, comprising
a cell stack including a solid electrolyte layer, and a positive electrode layer and a negative electrode layer disposed with the solid electrolyte layer interposed therebetween; and
a cover layer on an outer surface of the cell stack,
wherein the cover layer includes glass including lithium fluoride (LiF) or glass ceramic including lithium fluoride (LiF).

2. The all-solid-state battery of claim 1, wherein
the glass or glass ceramic includes the lithium fluoride (LiF) and lithium (Li) oxide.

3. The all-solid-state battery of claim 2, wherein
the glass or glass ceramic further includes silicon (Si) oxide, boron (B) oxide, phosphorus (P) oxide, germanium (Ge) oxide, or a combination thereof.

4. The all-solid-state battery of claim 3, wherein
the glass or glass ceramic includes 5 mol % to 15 mol % of the lithium fluoride (LiF), 20 mol % to 75 mol % of the lithium (Li) oxide, 0 mol % to 70 mol % of the silicon (Si) oxide, 0 mol % to 60 mol % of the boron (B) oxide, 0 mol % to 50 mol % of the phosphorus (P) oxide, and 0 mol % to 80 mol % of the germanium (Ge) oxide, based on a total amount of the glass or glass ceramic.

5. The all-solid-state battery of claim 1, wherein
the solid electrolyte layer includes glass including lithium (Li) oxide and lithium chloride (LiCl) or glass ceramic including lithium (Li) oxide and lithium chloride (LiCl).

6. The all-solid-state battery of claim 5, wherein
the glass or glass ceramic included in the solid electrolyte layer further includes silicon (Si) oxide, boron (B) oxide, phosphorus (P) oxide, germanium (Ge) oxide, or a combination thereof.

7. The all-solid-state battery of claim 6, wherein
the glass or glass ceramic included in the solid electrolyte layer includes 3 mol % to 22 mol % of the lithium chloride (LiCl), 20 mol % to 75 mol % of the lithium (Li) oxide, 0 mol % to 70 mol % of the silicon (Si) oxide, 0 mol % to 60 mol % of the boron (B) oxide, 0 mol % to 50 mol % of the phosphorus (P) oxide, and 0 mol % to 80 mol % of the germanium (Ge) oxide, based on a total amount of the glass or glass ceramic included in the solid electrolyte layer.

8. The all-solid-state battery of claim 1, wherein
the cover layer is disposed on an outer surface of the positive electrode layer or the negative electrode layer at an outermost side in the stacking direction of the cell stack.

9. The all-solid-state battery of claim 8, further comprising:
a solid electrolyte layer disposed between the cover layer and the positive electrode layer or the negative electrode layer adjacent thereto.

10. The all-solid-state battery of claim 1, wherein
the cell stack further includes a margin layer disposed laterally adjacent to edges of the positive electrode layer and the negative electrode layer, and
the margin layer includes glass including lithium fluoride (LiF) or glass ceramic including lithium fluoride (LiF).

11. An all-solid-state battery, comprising
a cell stack including:
a solid electrolyte layer,
a positive electrode layer and a negative electrode layer disposed with the solid electrolyte layer interposed therebetween, and
a margin layer disposed laterally adjacent to edges of the positive electrode layer and the negative electrode layer,
wherein the margin layer includes glass including lithium fluoride (LiF) or glass ceramic including lithium fluoride (LiF).

12. The all-solid-state battery of claim 11, wherein
the glass or glass ceramic includes 5 mol % to 15 mol % of the lithium fluoride (LiF), 20 mol % to 75 mol % of lithium (Li) oxide, 0 mol % to 70 mol % of silicon (Si) oxide, 0 mol % to 60 mol % of boron (B) oxide, 0 mol % to 50 mol % of phosphorus (P) oxide, and 0 mol % to 80 mol % of germanium (Ge) oxide, based on a total amount of the glass or glass ceramic.

13. The all-solid-state battery of claim 11, wherein
the solid electrolyte layer includes glass or glass ceramic including 3 mol % to 22 mol % of lithium chloride (LiCl), 20 mol % to 75 mol % of lithium (Li) oxide, 0 mol % to 70 mol % of silicon (Si) oxide, 0 mol % to 60 mol % of boron (B) oxide, 0 mol % to 50 mol % of phosphorus (P) oxide, and 0 mol % to 80 mol % of germanium (Ge) oxide, based on a total amount of the glass or glass ceramic.

14. The all-solid-state battery of claim 11, wherein
the margin layer extends along an edge of an electrode active material layer of the positive electrode layer or the negative electrode layer.

15. The all-solid-state battery of claim 14, wherein
the margin layer is stacked on the solid electrolyte layer.

16. The all-solid-state battery of claim 11, further comprising a cover layer on an outer surface of the cell stack.

17. The all-solid-state battery of claim 1, wherein
a first external electrode disposed adjacent to one side of the cell stack and the cover layer and connected to the positive electrode layer, and
a second external electrode disposed adjacent to the other side of the cell stack and the cover layer and connected to the negative electrode layer.

18. The all-solid-state battery of claim 17, wherein
the positive electrode layer includes a positive electrode current collector and a positive electrode active material layer coated on at least one surface of the positive electrode current collector, and
the negative electrode layer includes a negative electrode current collector and a negative electrode active material layer coated on at least one surface of the negative electrode current collector.

19. The all-solid-state battery of claim 18, wherein
the positive electrode current collector extends toward the one side of the cell stack and is connected to the first external electrode, and
the negative electrode current collector extends toward the other side of the cell stack and is connected to the second external electrode.

20. A stacked all-solid-state battery, comprising
a cell stack including:
a plurality of solid electrolyte layers,
a plurality of positive electrode layers and negative electrode layers alternately disposed with the plurality of solid electrolyte layers interposed therebetween, and
a plurality of margin layers disposed laterally adjacent to edges of the plurality of positive electrode layers and the plurality of negative electrode layers;
cover layers on outer surfaces of the cell stack in a stacking direction of the plurality of positive electrode layers and negative electrode layers; and
first and second external electrodes disposed laterally adjacent to the cell stack and the cover layers and connected to the plurality of positive electrode layers and the plurality of negative electrode layers, respectively,
wherein the plurality of margin layers, the cover layers, or both of the plurality of margin layers and the cover layers include glass including lithium fluoride (LiF) or glass ceramic including lithium fluoride (LiF).
